(19) United States
(12) Patent Application Publication
(10) Pub. No.: US 2013/0147702 A1
(43) Pub. Date: Jun. 13, 2013

(54) Method, Apparatus, Computer Program and User Interface

(71) Applicants: Viljakaisa Aaltonen, Tampere (FI); Teemu Tuomas Ahmaniemi, Helsinki (FI); Juha Henrik Arrasvuori, Tampere (FI); Jan Peter Erik Eskolin, Pirkkala (FI); Tero Simo llari Jokela, Tampere (FI); Johan Kildal, Helsinki (FI); Andres Lucero, Tampere (FI); Pii Susanna Paasovaara, Lempaala (FI); Erika Reponen, Tampere (FI); Janne Vainio, Pirkkala (FI)

(72) Inventors: Viljakaisa Aaltonen, Tampere (FI); Teemu Tuomas Ahmaniemi, Helsinki (FI); Juha Henrik Arrasvuori, Tampere (FI); Jan Peter Erik Eskolin, Pirkkala (FI); Tero Simo llari Jokela, Tampere (FI); Johan Kildal, Helsinki (FI); Andres Lucero, Tampere (FI); Pii Susanna Paasovaara, Lempaala (FI); Erika Reponen, Tampere (FI); Janne Vainio, Pirkkala (FI)

(73) Assignee: Nokia Corporation, Espoo (FI)

(21) Appl. No.: 13/324,344

(22) Filed: Dec. 13, 2011

(51) Int. Cl. G09G 5/00; G05B 19/02

(52) U.S. Cl. 345/156; 340/4.31

(57) ABSTRACT

A method, apparatus, computer program and user interface wherein the method comprises: detecting a user input at a first apparatus; determining that the user input was also detectable by a second apparatus; and causing a function to be performed where at least part of the function is performed by the first apparatus and at least part of the function is performed by the second apparatus.

### TECHNOLOGICAL FIELD

Embodiments of the present disclosure relate to a method, apparatus, computer program and user interface. In particular, they relate to a method, apparatus, computer program and user interface which enable a function involving two or more apparatus to be carried out.

### BACKGROUND

Apparatus which are configured to communicate with other apparatus are known. For example apparatus such as mobile telephones or other types of electronic apparatus can communicate with other apparatus via networks such as Bluetooth networks or other low power radio frequency networks. Such networks may enable the apparatus to communicate directly with each other without any intermediate devices.

Such communication networks may enable a function to be performed which involves two or more apparatus. For example, they may enable data to be transferred from one apparatus to another. It is useful to provide a simple method enabling the user to control the apparatus to perform such functions.

### BRIEF SUMMARY

According to various, but not necessarily all, embodiments of the disclosure there is provided a method comprising: detecting a user input at a first apparatus; determining that the user input was also detectable by a second apparatus; and causing a function to be performed where at least part of the function is performed by the first apparatus and at least part of the function is performed by the second apparatus.

In some embodiments of the disclosure the user input may comprise bringing a user input object into proximity of both the first apparatus and the second apparatus so that the user input object is simultaneously detectable by both the first apparatus and the second apparatus.

In some embodiments of the disclosure the user input may comprise bringing a user input object into proximity of the first apparatus, so that the user input object is detectable by the first apparatus, and moving the user input object to a region where it is in proximity of both the first apparatus and the second apparatus so that the user input object is simultaneously detectable by both the first apparatus and the second apparatus.

In some embodiments of the disclosure the user input may comprise a hover input which is simultaneously detectable by both the first apparatus and the second apparatus.

In some embodiments of the disclosure the method may comprise determining, by the first apparatus that the second apparatus is proximate to the first apparatus.

In some embodiments of the disclosure the method may comprise determining that the first apparatus is tilted relative to the second apparatus.

In some embodiments of the disclosure the method may comprise establishing a communication link between the first and second apparatus.

In some embodiments of the disclosure the communication link may comprise a wireless communication link.

In some embodiments of the disclosure the communication link may comprise a short range wireless communication link.

In some embodiments of the disclosure the method may comprise receiving a notification from the second apparatus indicating that the second apparatus has also detected the user input.

In some embodiments of the disclosure the notification may be received over the communication link.

In some embodiments of the disclosure the function which is performed may comprise transferring information between the first apparatus and the second apparatus.

In some embodiments of the disclosure the function which is performed may comprise establishing a further communication link between the first apparatus and the second apparatus.

In some embodiments of the disclosure the function which is performed may comprise coordinating a display of the first apparatus and a display of the second apparatus so that corresponding content may be simultaneously displayed on both the display of the first apparatus and the display of the second apparatus.

In some embodiments of the disclosure the function which is performed may depend upon the user input which is detected.

According to various, but not necessarily all, embodiments of the disclosure there is provided an apparatus comprising: at least one processor; and at least one memory including computer program code; wherein the at least one memory and the computer program code are configured to, with the at least one processor, enable the apparatus to: detect a user input of the apparatus; determine that the user input was also detectable by another apparatus; and cause a function to be performed where at least part of the function is performed by the apparatus and at least part of the function is performed by the another apparatus.

In some embodiments of the disclosure the user input may comprises bringing a user input object into proximity of both the apparatus and the another apparatus so that the user input object is simultaneously detectable by both the apparatus and the another apparatus.

In some embodiments of the disclosure the user input may comprise bringing a user input object into proximity of the apparatus, so that the user input object is detectable by the apparatus, and moving the user input object to a region where it is in proximity of both the apparatus and the another apparatus so that the user input object is simultaneously detectable by both the apparatus and the another apparatus.

In some embodiments of the disclosure the user input may comprise a hover input which is simultaneously detectable by both the apparatus and the another apparatus.

In some embodiments of the disclosure the at least one memory and the computer program code may be configured to, with the at least one processor, enable the apparatus to determine that the another apparatus is proximate to the apparatus.

In some embodiments of the disclosure the at least one memory and the computer program code may be configured to, with the at least one processor, enable the apparatus to determine that the apparatus is tilted relative to the another apparatus.

In some embodiments of the disclosure the at least one memory and the computer program code may be configured to, with the at least one processor, enable the apparatus to establish a communication link between the apparatus and the another apparatus.

In some embodiments of the disclosure the communication link may comprise a wireless communication link.

In some embodiments of the disclosure the communication link may comprise a short range wireless communication link.

In some embodiments of the disclosure the at least one memory and the computer program code may be configured to, with the at least one processor, enable the apparatus to receive a notification from the another apparatus indicating that the another apparatus has also detected the user input.

In some embodiments of the disclosure the notification may be received over the communication link.

In some embodiments of the disclosure the function which is performed may comprise transferring information between the apparatus and the another apparatus.

In some embodiments of the disclosure the function which is performed may comprise establishing a further communication link between the apparatus and the another apparatus.

In some embodiments of the disclosure the function which is performed may comprise coordinating a display of the apparatus and a display of the another apparatus so that corresponding content may be simultaneously displayed on both the display of the apparatus and the display of the another apparatus.

In some embodiments of the disclosure the function which is performed may depend upon the user input which is detected.

According to various, but not necessarily all, embodiments of the disclosure there is provided a computer program comprising computer program instructions that, when executed by at least one processor, cause an apparatus at least to perform: detecting a user input at a first apparatus; determining that the user input was also detectable by a second apparatus; and causing a function to be performed where at least part of the function is performed by the first apparatus and at least part of the function is performed by the second apparatus.

In some embodiments of the disclosure there may be provided a computer program comprising program instructions for causing a computer to perform the method as described above.

In some embodiments of the disclosure there may be provided a physical entity embodying the computer program as described above.

In some embodiments of the disclosure there may be provided an electromagnetic carrier signal carrying the computer program as described above.

According to various, but not necessarily all, embodiments of the disclosure there is provided a user interface comprising: a user input device configured to detect a user input at an apparatus wherein the user input is also detectable by a user input device at another apparatus such that, in response to determining that the user input has also been detected at the another apparatus a function is caused to be performed where at least part of the function is performed by the apparatus and at least part of the function is performed by the another apparatus.

In some embodiments of the disclosure the user input comprises bringing a user input object into proximity of both the apparatus and the another apparatus so that the user input object is simultaneously detectable by both the apparatus and the another apparatus.

The apparatus may be for wireless communication.

### BRIEF DESCRIPTION

For a better understanding of various examples of embodiments of the present disclosure reference will now be made by way of example only to the accompanying drawings in which:

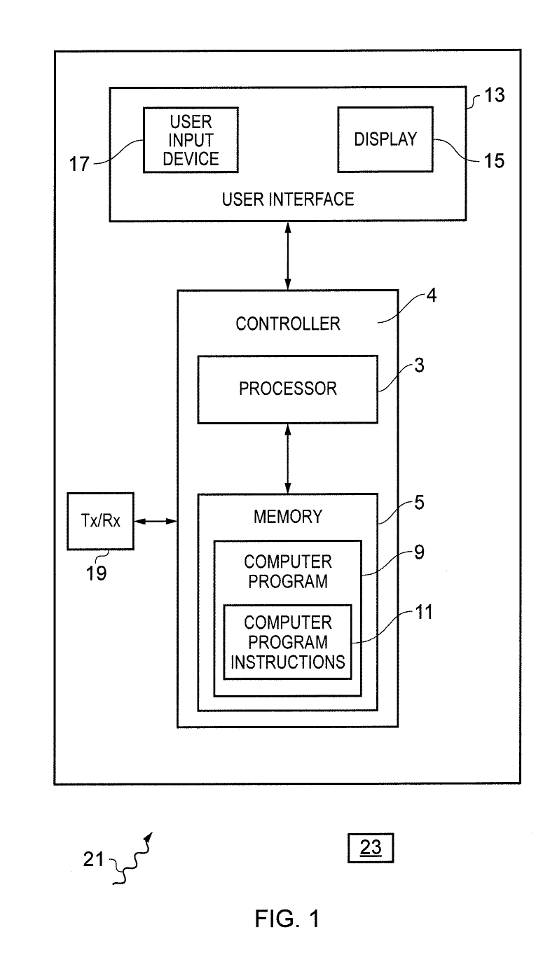

FIG. 1 schematically illustrates an apparatus according to an embodiment of the disclosure;

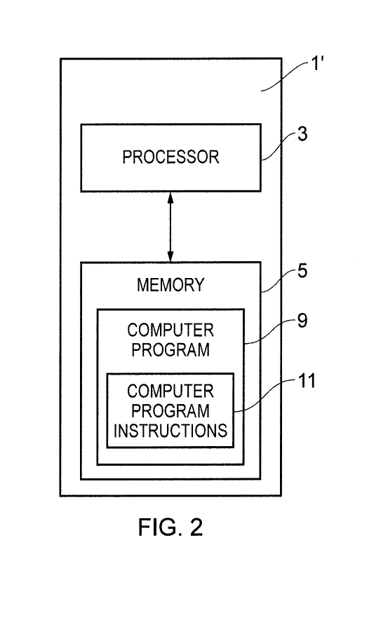

FIG. 2 illustrates an apparatus according to another embodiment of the disclosure;

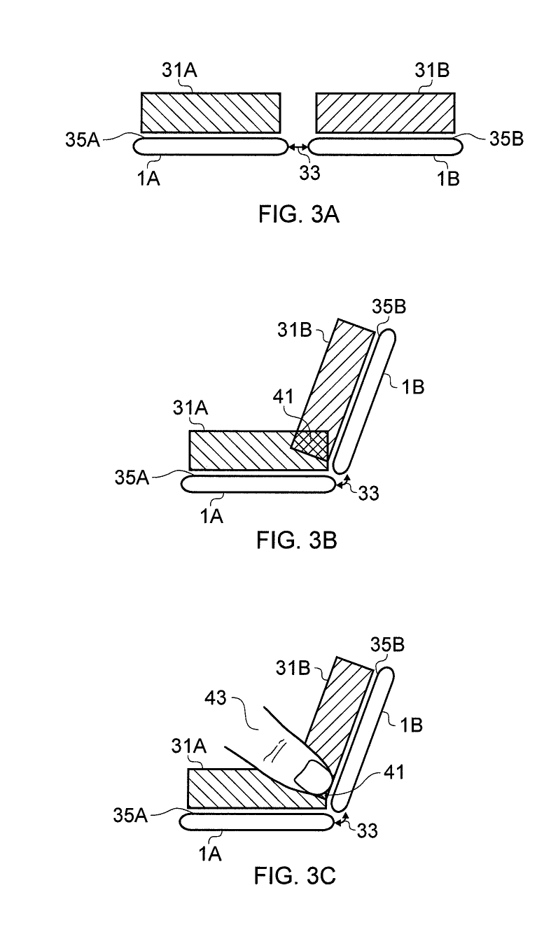

FIGS. 3A to 3C illustrate two apparatus configured in proximity to each other;

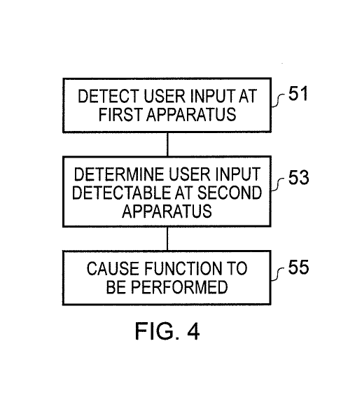

FIG. 4 schematically illustrates a method according to an embodiment of the disclosure;

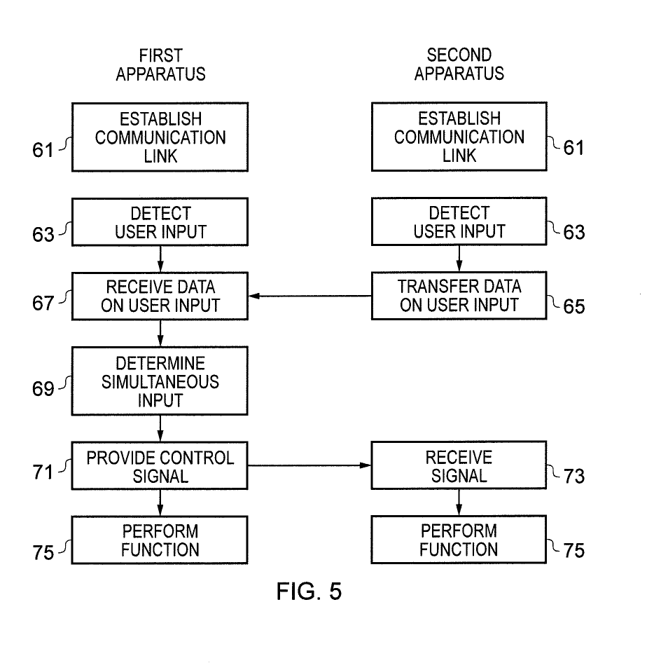

FIG. 5 schematically illustrates another method according to an embodiment of the disclosure;

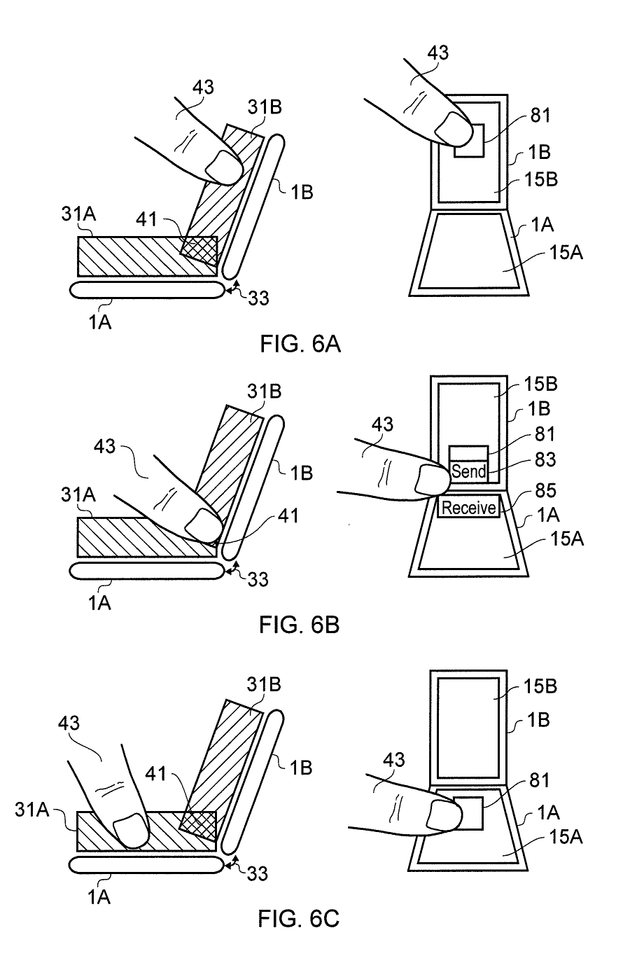

FIGS. 6A to 6C illustrate an example embodiment of the disclosure in use;

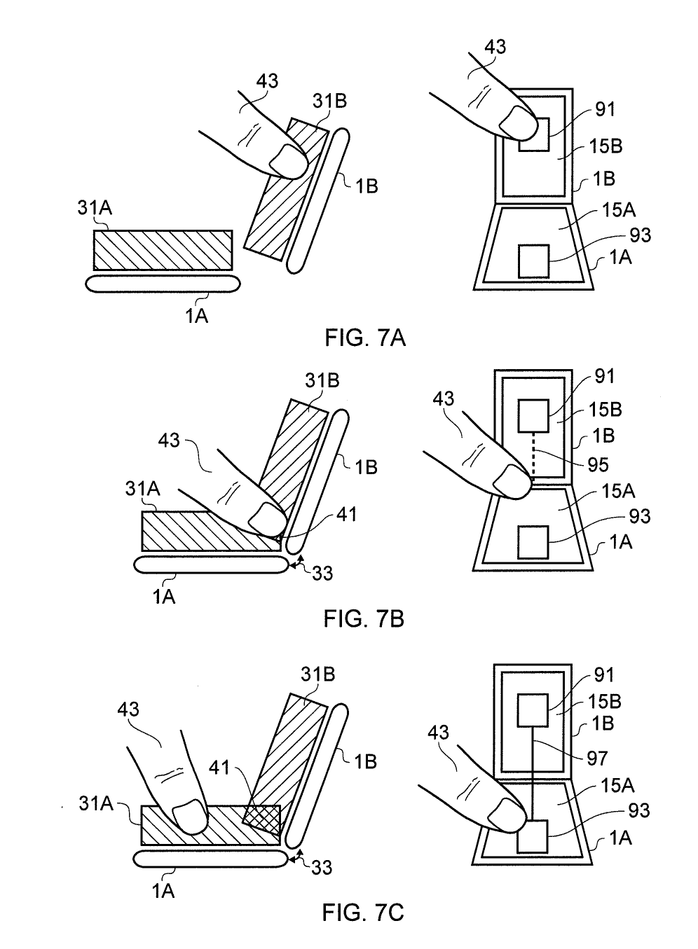

FIGS. 7A to 7C illustrate another example embodiment of the disclosure in use; and

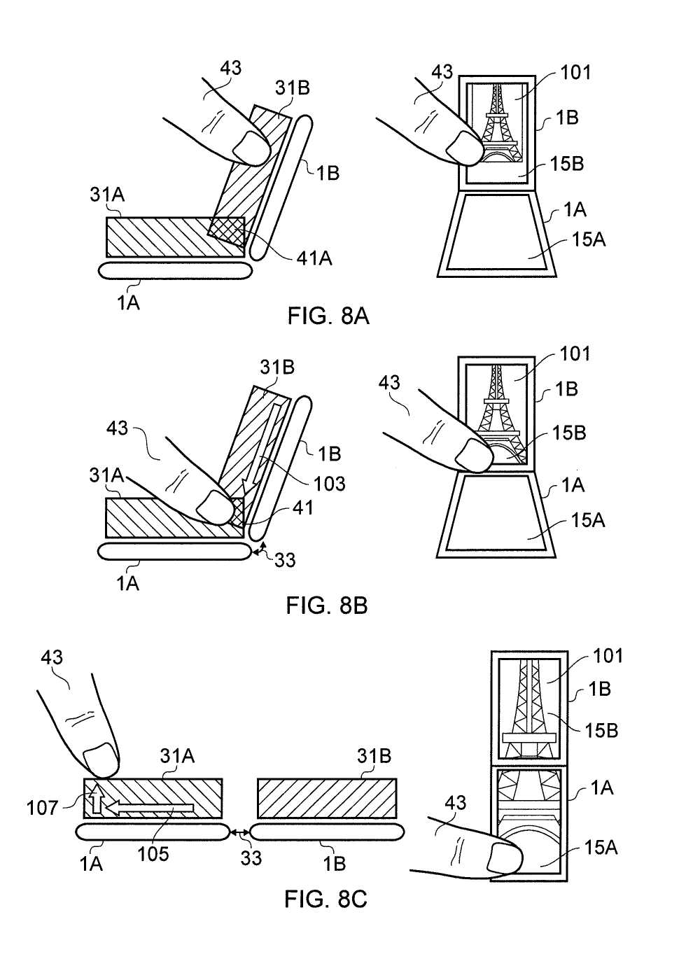

FIGS. 8A to 8C illustrate a further example embodiment of the disclosure in use.

### DETAILED DESCRIPTION

The Figures illustrate a method, apparatus 1, computer program and user interface 13 wherein the method comprises: detecting 51, 63 a user input at a first apparatus 1A; determining 53, 69 that the user input was also detectable by a second apparatus 1B; and causing 55, 71 a function to be performed where at least part of the function is performed by the first apparatus 1A and at least part of the function is performed by the second apparatus 1B.

FIG. 1 schematically illustrates an apparatus 1 according to an embodiment of the disclosure. The apparatus 1 may be an electronic apparatus. The apparatus 1 may be, for example, a mobile cellular telephone, a tablet computer, a personal computer, a camera, a gaming device, a personal digital assistant, a personal music player or any other apparatus which may be configured to establish a communication link 33 with another apparatus so that a function may be performed which involves both apparatus. The apparatus 1 may be a handheld apparatus 1 which can be carried in a user's hand, handbag or pocket of their clothes for example.

Only features referred to in the following description are illustrated in FIG. 1. However, it should be understood that the apparatus 1 may comprise additional features that are not illustrated. For example, in some embodiments the user interface 13 may comprise other user output devices such as a loudspeaker or other means for providing audio outputs to the user of the apparatus 1.

The apparatus 1 illustrated in FIG. 1 comprises: a user interface 13, a controller 4 and a transceiver 19. In the illustrated embodiment the controller 4 comprises at least one processor 3 and at least one memory 5 and the user interface 13 comprises a display 15 and a user input device 17. In the illustrated embodiment the transceiver 19 is shown as a single entity. It would be appreciated by a person skilled in the art that the transceiver 19 may comprise one or more separate receivers and transmitters.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc) to be executed by such processors 3.

The controller 4 may be configured to control the apparatus 1 to perform a plurality of different functions. For example, where the apparatus 1 is configured to communicate with other apparatus the controller 4 may be configured to control the apparatus 1 to establish communication links with other apparatus. In some embodiments the controller 4 may control the apparatus 1 to access communication network such as wireless local area networks or an adhoc communication network such as a Bluetooth network.

The controller 4 may also be configured to enable the apparatus 1 to detect 51, 63 a user input of the apparatus 1; determine 53, 69 that the user input was also detectable by another apparatus; and cause 55, 71 a function to be performed where at least part of the function is performed by the apparatus 1 and at least part of the function is performed by the another apparatus.

The at least one processor 3 is configured to receive input commands from the user interface 13 and also to provide output commands to the user interface 13. The at least one processor 3 is also configured to write to and read from the at least one memory 5. Outputs of the user interface 13 are provided as inputs to the controller 4.

The display 15 may comprise any means which enables information to be displayed to a user of the apparatus 1. The information which is displayed may comprise graphical user interfaces, content such as pictures or images or videos or menus structures or any other suitable information. The information which is displayed on the display 15 may be stored in the one or more memories 5. The information which is displayed on the display 15 may be received by the transceiver 19.

The user input device 17 provides means for enabling a user of the apparatus 1 to input information which may be used to control the apparatus 1. The user input device 17 may also enable a user to input information which may be stored in the one or more memories 5 of the apparatus 1. The user input device 17 may comprise any means which enables a user to input information into the apparatus 1. For example the user input device 17 may comprise a keypad or a portion of a touch sensitive display or a combination of a number of different types of user input devices.

In some example embodiments of the disclosure the user input device 17 may be configured to detect a hover input. A hover input may comprise a user bringing a user input object 43 into proximity of the apparatus 1 without actually touching the apparatus 1. In such embodiments the user input device 17 may be configured to detect objects which are brought, for example within a range of approximately five centimetres of the user input device 17.

In such embodiments the user input device 17 may comprise an area on the surface of the housing of the apparatus 1 which is configured to be responsive to hover inputs. The area may comprise a plurality of sensors which are configured to detect when a user input object 43 is brought into proximity of the sensors. By determining which of the plurality of sensors have been actuated the controller 4 may determine the relative location of the user input on the surface of the housing of the apparatus 1. The controller 4 may also be configured to detect the height of the user input object above the surface of the housing of the apparatus 1. The controller 4 may be configured to receive inputs from the plurality of sensors to determine movement of the user input object 43. The movement of the user input object 43 may comprise components which are parallel to the surface of the apparatus 1 and components which are perpendicular to the surface of the apparatus 1.

In an example embodiment the plurality of sensors may comprise an array of capacitive sensors which may be configured to create an electromagnetic field above the surface of the housing of the apparatus 1. When a user input object is positioned within the electromagnetic field this causes a change in the electromagnetic field which may be detected by the array of sensors.

In some embodiments of the disclosure the hover user input device may be integrated with other user input devices. For example the hover user input device may be integrated with a touch sensitive display 15 so that the touch sensitive display 15 is configured to detect a user touching the surface of the display 15 and also bringing a user input object 43 into proximity with the surface of the touch sensitive display 15.

It is to be appreciated that in other embodiments of the disclosure the user input device 1 may comprise any other suitable means for detecting a hover input. For example, a camera or other imaging device may be used to detect when a user input object 43 is brought into proximity of the apparatus 1.

The user input object 43 which is used to make a hover input may comprise any object which the user input device 17 may be configured to detect. For example the user input object 43 may comprise part of a user such as a finger or thumb or a stylus.

The apparatus 1 illustrated in FIG. 1 also comprises a transceiver 19. The transceiver 19 may comprise any means which enables the apparatus 1 to receive data from another apparatus. The transceiver 19 may enable the apparatus 1 to establish a communication link 33 with another apparatus so that data may be exchanged between the apparatus 1 and the another apparatus. The communication link 33 may enable the data to be exchanged directly between the two apparatus without any intermediary device.

In some embodiments of the disclosure the transceiver 19 may be configured to enable wireless communication. For example the transceiver 19 may enable short range wireless communication. In such embodiments the transceiver 19 may be configured to operate in a frequency band according to a radio communication protocol such as Bluetooth (2400-2483.5 MHz), WLAN (wireless local area network) (2400-2483.5 MHz) or NFC (near field communication) (13.56 MHz). The communication range may be may be several centimeters.

In some embodiments of the disclosure the transceiver 19 may also be configured to enable long range wireless communication. For example the transceiver 19 may be configured to operate in a cellular communications network.

In some embodiments of the disclosure the transceiver 19 may be configured to enable wired communication between the apparatus 1 and another apparatus. For example, the transceiver 19 may enable a physical connection to be made between the apparatus 1 and another apparatus so that data may be transmitted via the physical connection. The physical connection may comprise, for instance, a USB cable.

The controller 4 may be configured to provide information to the transceiver 19 for transmission over a communication link 33 to another apparatus. The controller 4 may also be configured to decode signals received from the another apparatus by the transceiver 19 into information. The received information may be stored in the one or more memories 5 or used to control the apparatus 1 to perform a function.

It the illustrated embodiment the transceiver 19 has been illustrated as a single entity. It is to be appreciated by a person skilled in the art that, in some embodiments of the disclosure, the transceiver 19 may comprise a separate transmitter and receiver.

The at least one memory 5 stores a computer program code 9 comprising computer program instructions 11 that control the operation of the apparatus 1 when loaded into the at least one processor 3. The computer program instructions 11 provide the logic and routines that enable the apparatus 1 to perform the methods illustrated in FIGS. 4 and 5. The at least one processor 3 by reading the at least one memory 5 is able to load and execute the computer program 9.

The computer program instructions 11 may provide computer readable program means configured to control the apparatus 1. The program instructions 11 may provide, when loaded into the controller 4; means for detecting 51, 63 a user input at a first apparatus 1; means for determining 53, 69 that the user input was also detectable by a second apparatus; and means for causing 55, 71 a function to be performed where at least part of the function is performed by the first apparatus and at least part of the function is performed by the second apparatus.

The computer program code 9 may arrive at the apparatus 1 via any suitable delivery mechanism 21. The delivery mechanism 21 may be, for example, a computer-readable storage medium, a computer program product 23, a memory device, a record medium such as a CD-ROM or DVD, an article of manufacture that tangibly embodies the computer program code 9 or any other suitable mechanism. The delivery mechanism may be a signal configured to reliably transfer the computer program code 9. The apparatus 1 may propagate or transmit the computer program code 9 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application specific integration circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 2 illustrates an apparatus 1′ according to another embodiment of the disclosure. The apparatus 1′ illustrated in FIG. 2 may be a chip or a chip-set. The apparatus 1′ comprises at least one processor 3 and at least one memory 5 as described above in relation to FIG. 1.

FIGS. 3A to 3C illustrate two apparatus 1A, 1B which may be configured so that a single user input can be detected by both the first apparatus 1A and the second apparatus 1B. The two apparatus 1A, 1B may be apparatus 1 such as the apparatus 1 schematically illustrated in FIG. 1. In the following description the suffix A is used to refer to components of the first apparatus 1A and the suffix B is used to refer to components of the second apparatus 1B.

In FIGS. 3A to 3C each of the two apparatus 1A, 1B comprises a user input device 17 which is configured to detect a hover input. A hover input region 31A, 31B is provided above the surface 35A, 35B of the housing of each of the apparatus 1A, 1B. The hover input region 31A, 31B represents the area around the apparatus 1A, 1B within which the hover user input device 17 may detect a hover user input. If a user input object is brought into the hover input region 31A, 31B or moved within the hover input region 31A, 31B then the hover user input device 17 may detect this and provide an appropriate output signal to the controller 4. If the user input object 43 is positioned outside the hover input region 31A, 31B then the user input object 43 is too far away to actuate the hover user input device 17 and no user input is detected.

In FIGS. 3A to 3C the apparatus 1A, 1B have a substantially flat planar surface 35A, 35B. The user input device 17 which is configured to detect a hover input is provided on the substantially flat planar surfaces 35A, 35B. A display 15 such as a touch sensitive display may also be provided on the substantially flat planar surface 35A, 35B. In the illustrated embodiment of FIGS. 3A to 3C the hover input regions 31A, 31B have a substantially rectangular cross section. The width of the hover input region 31A, 31B extends to the edges of the housing of the apparatus 1A, 1B. The height of the hover input region 31A, 31B above the surface of the housing of the apparatus 1A, 1B may be around 5 cm.

It is to be appreciated that the size and shape of the hover input regions 31A, 31B may depend on a plurality of factors such as the type and configuration of user input device 17 used to detect the hover input and the size and shape of the apparatus 1A, 1B. Although in FIGS. 3A to 3C the hover input regions 31A, 31B are substantially the same size and shape, it is to be appreciated that in other embodiments of disclosure the hover input regions 31A, 31B may be of different sizes and shapes for each of the apparatus 1A, 1B.

The hover input region 31A, 31B is illustrated schematically in FIGS. 3A to 3C to aid with the explanation of the embodiments of the disclosure. It is to be appreciated that the hover input region might not be visible to a user of the apparatus 1A, 1B.

In FIG. 3A the two apparatus 1A, 1B are positioned proximate to each other. The two apparatus 1A, 1B may be positioned within a few centimetres of each other. In some embodiments of the disclosure the two apparatus 1A, 1B may be positioned adjacent to each other. In some embodiments of the disclosure the two apparatus 1A, 1B may be physically touching each other.

In FIG. 3A a communication link 33 may be established between the two apparatus 1A, 1B. The communication link 33 may comprise any means which enables data to be transferred between the two apparatus 1A. 1B.

The communication link 33 may comprise a wireless communication link. In some embodiments the wireless communication link may comprise a short range wireless communication link such as, a low power radio frequency link such as a Bluetooth connection, or a near field communication link. In other embodiments of the disclosure the communication link 33 may comprise a physical connection, such as a USB (universal serial bus) connection, between the two apparatus 1A, 1B.

The establishment of the communication link 33 may involve a procedure being carried out by both of the apparatus 1A, 1B. For example, a security protocol may be carried out or some identification data may be transferred between the two apparatus 1A, 1B. In other embodiments of the disclosure the establishment of the communication link 33 may be carried out by just one of the apparatus 1A, 1B.

In some embodiments of the disclosure the two apparatus 1A, 1B may be positioned proximate to each other in order to enable the communication link 33 to be established. For example the two apparatus 1A, 1B may be positioned within a few centimeters of each other, or where a physical connection is used they may be brought into contact with each other. In such embodiments of the disclosure, the apparatus 1A, 1B may comprise means for detecting the proximity of the other apparatus. Such means may comprise, for example, a proximity sensor or Bluetooth or a wireless LAN communication means.

In FIG. 3A the two apparatus 1A, 1B are positioned proximate to each other and in horizontal alignment with each other so that the substantially flat planar surfaces 35A, 35B are substantially in the same plane as each other. The angle of inclination of the second apparatus 1B relative to the first apparatus 1A is approximately 180 degrees. The two hover input regions 31A, 31B are positioned side by side with no overlap between them.

In FIG. 3B the second apparatus 1B has been tilted relative to the first apparatus 1A. The second apparatus 1B may be tilted manually or mechanically.

It is to be appreciated that either apparatus 1A, 1B could be tilted with respect to the other apparatus 1A, 1B. The second apparatus 1B has been tilted so that the substantially flat planar surface 35B of the first apparatus 1A is inclined at an angle of less than 180 degrees to the substantially flat planar surface 35A of the first apparatus 1A. In the particular embodiment illustrated in FIG. 3B the substantially flat planar surface 35B of the first apparatus 1A is inclined at an angle of between 90 and 135 degrees to the substantially flat planar surface 35A of the first apparatus 1A.

As the two apparatus are now inclined relative to each other the two hover input regions 31A, 31B are no longer positioned side by side but are now overlapping. There is an overlap region 41 which is part of both the hover input region 31A of the first apparatus 1A and the hover input region 31B of the second apparatus 1B.

It is to be appreciated that the relative positions of the two apparatus 1A, 1B may be any positions which cause an overlap of the hover input regions 31A, 31B. Therefore the positions of the two apparatus 1A, 1B which may be used in the embodiments of the disclosure may be determined by the size and shape of the hover input regions 31A, 31B.

In FIG. 3C a user has placed a user input object 43 in the overlap region 41.

As the overlap region 41 is part of both the hover input region 31A of the first apparatus 1A and the hover input region 31B of the second apparatus 1B the user input object 43 may be detected by both the first apparatus 1A and the second apparatus 1 B. Each of the two apparatus 1 may be configured to independently detect the user input object 43 in the overlap region 41.

The two apparatus 1A, 1B may then use the communication links 33 to exchange information relating to detected user inputs. If it is determined that the apparatus 1A, 1B have detected a user input simultaneously then this may be determined to have been a user input in the overlap region 41. The controllers 4A, 4B of the respective apparatus 1A, 1B may then cause a function to be performed corresponding to an actuation of the overlap region 41.

FIGS. 4 and 5 illustrate methods according to embodiments of the disclosure.

The method illustrated in FIG. 4 may be performed by either of the apparatus 1A, 1B illustrated in FIGS. 3A to 3C, however in this example embodiment the method is described as occurring at the first apparatus 1A.

25

At block 51 the controller 4A detects a user input which has been made at the first apparatus 1A. The user input may comprise positioning a user input object 43 into the hover input region 31A of the first apparatus 1A. In the example embodiment the apparatus 1A may be positioned proximate to a second apparatus 1B so that the two apparatus 1A, 1B have a communication link 33 between them and an overlap region 41 of hover input areas. FIGS. 3B and 3C illustrate an example configuration of the apparatus 1A, 1B. The user input which is detected at block 51 may comprise positioning a user input object 43 into the overlap region 41.

At block 53 the controller 4A of the first apparatus 1A determines that the user input which was detected at block 51 was also detectable by the second apparatus 1B. For example, the first apparatus 1A may receive a notification 1B from the second apparatus 1B indicating that the second apparatus 1B has also detected the same user input. The notification may be received over the communication link 33.

The controller 4A may be configured to determine that the user input which has been detected by the second apparatus 1B is the same as the user input which has been detected by the first apparatus 1A. This may be done by comparing information such as the time of the detected inputs, the relative positions of the detected inputs, the user input object 43 which was used to make the user input, the relative angle of inclination between the two apparatus 1A, 1B or any other suitable information. If it is determined that both the first apparatus 1A and the second apparatus 1B have detected the same input then the controller 4A may determine that the overlap region 41 has been actuated and provide an appropriate output signal. The output signal may comprise any output which may be detected by the user of the apparatus 1A, 1B. For example the output signal may comprise a visual output, such a notification displayed on a display or an illumination of a light such as an LED, the output may also comprise an audio signal which may be provided by a loudspeaker or a tactile indication such as vibration of one or both of the apparatus 1A, 1B or any other tactile feedback.

Once it has been determined that the same input has been detected by both the first apparatus and the second apparatus, at block 55, the control signal which is provided by the controller 4A causes the apparatus 1A to perform a function where at least part of the function is performed by the first apparatus 1A and at least part of the function is performed by the second apparatus 1B.

Examples of functions which may be carried out by the two apparatus 1A, 1B are illustrated in FIGS. 6 to 8 and include establishing a further communication link between the two apparatus 1A, 1B, transferring data between the two apparatus 1A, 1B and coordinating a display 15A of the first apparatus 1A with a display 15B of the second apparatus 1B so that corresponding content may be simultaneously displayed on both the display 15A of the first apparatus 1A and the display 15B of the second apparatus 1B. It is to be appreciated that in other embodiments other functions may be performed.

In some embodiments the controller 4A of the first apparatus 1A may also cause a signal to be transmitted to the second apparatus 1B indicating that the same user input has been detected by both apparatus 1A, 1B. This signal may be transmitted over the communication link 33. This signal may cause the second apparatus 1B to perform the parts of the function initiated by the actuation of the hover region 41. In other embodiments the controller 4B of the second apparatus 1B may determine that the hover region 41 has been actuated and may provide an appropriate control signal which causes the second apparatus 1B to perform the respective parts of the function.

FIG. 5 illustrates a method comprising blocks which may be carried by the first apparatus 1A and also the second apparatus 1B. The method may be performed by two apparatus 1A, 1B which are positioned proximate to each other. The two apparatus 1A, 1B may be tilted relative to each other as indicated in FIG. 3B and 3C.

At block 61 a communication link 33 is established between the first apparatus 1A and the second apparatus 1B. As described above the communication link 33 may comprise any means which enables information to be transferred between the two apparatus 1A, 1B and may involve a procedure being carried out by both of the apparatus 1A, 1B. In order for the communication link 33 to be established it may be necessary for the two apparatus 1A, 1B to be positioned proximate to each other. For example, in some embodiments of the disclosure the two apparatus 1A, 1B may need to be within a few centimetres of each other.

At block 63 both the first apparatus 1A and the second apparatus 1B detect a user input. The two apparatus 1A, 1B may detect the user input independently of each other. The user input which is detected may comprise a hover input in which the user places a user input object 43 into the hover input regions 31A, 31B. If the user places the user input object 43 into the overlap region 41 then this input may be detected simultaneously by both the first apparatus 1A and the second apparatus 1B.

At block 65 the second apparatus 1B transmits a notification to the first apparatus 1A indicating that the second apparatus 1B has detected a user input. The notification may include information relating to the user input which has been detected. The information may enable the controller 4A of the first apparatus 1A to determine that the actuation occurred in the overlap region 41. The notification may include information such as the time of the user input, the relative location of the area which has been actuated, the type of user input object 43 which has been used the angle of inclination of the second apparatus 1B or any other suitable information. The notification may be sent over the communication link 33 which was established in block 61.

At block 67 the first apparatus 1A receives the notification from the second apparatus 1B. The controller 4A of the first apparatus 1A compares the information relating to the input which was detected by the second apparatus 1B with information relating to the input which was detected by the first apparatus.

At block 69 the controller 4A of the first apparatus 1A determines that the overlap region 41 has been actuated. The controller 4A will determine that the overlap region 41 has been actuated if there is a correlation between the user input detected by the first apparatus 1A and the user input detected by the second apparatus 1B. For example, if user input detected by the first apparatus 1A and the user input detected by the second apparatus 1B are determined to have occurred at the same time or if the inputs are determined to have occurred in the same location.

At block 71, in response to determining that the overlap region 41 has been actuated, the controller 4A of the first apparatus 1A may provide a control signal that causes a function to be performed. The control signal may cause the transceiver 19A to transmit a notification to the second apparatus 1B indicating that the overlap region has been actuated. The notification may be transmitted over the communication link 33.

At block 73 the second apparatus 1B receives the notification from the first apparatus 1A. The notification may cause the second apparatus 1B to perform at least part of the function.

At block 75 a function is performed by both the first apparatus 1A and the second apparatus 1B. At least part of the function is performed by the first apparatus 1A and at least part of the function is performed by the second apparatus 1B. Examples of functions which may be carried out by the two apparatus 1A, 1B are illustrated in FIGS. 6 to 8.

In the above described example embodiment only the controller 4A of the first apparatus 1A determines whether or not the user input was detectable by both the first and second apparatus 1A, 1B. The first apparatus 1A is then configured to send a notification to the second apparatus 1B to cause the second apparatus 1B to perform the function.

In other embodiments of the disclosure the second apparatus 1B may also be configured to determine whether or not the user input was detectable by both the first and second apparatus 1A, 1B and may cause the function to be performed in response to a control signal provided by the controller 4B of the second apparatus 1B. This may enable the two apparatus 1A, 1B to detect the same input independently of each other and cause the function to be performed without having to transmit a control signal between the two apparatus 1A, 1B.

The blocks illustrated in the FIGS. 4 and 5 may represent steps in a method and/or sections of code in the computer program 9. The illustration of a particular order to the blocks does not necessarily imply that there is a required or preferred order for the blocks and the order and arrangement of the block may be varied. Furthermore, it may be possible for some blocks to be omitted.

FIGS. 6A to 6C illustrate an example embodiment of the disclosure in use. The Figures on the left represent a side view of the two apparatus 1A, 1B and the figures on the right represent the same apparatus 1A, 1B from the front and indicate the displays 15A, 15B of the apparatus 1A, 1B.

In FIG. 6A the two apparatus 1A, 1B are positioned proximate to each other. A communication link 33 is established between the two apparatus 1A 1B so that the apparatus 1A, 1B can share information regarding hover inputs which have been detected.

In FIG. 6A the apparatus 1A, 1B are tilted relative to each other so that there is an overlap region 41 of the hover input regions 31A, 31B.

In FIG. 6A the user makes a user input by positioning a user input object 43 within the hover input region 31B of the second apparatus 1B. As the user input object 43 is only within the hover input region 31B of the second apparatus 1B and not the hover input region 31A of the first apparatus 1A the initiation of the user input is only detected by the second apparatus 1B and not by the first apparatus 1A.

The user input illustrated in FIG. 6A may cause selection of an item 81 displayed on the display 15B of the second apparatus 1B. The item 81 may represent a file or content which the user wishes to transfer from the second apparatus 1B to the first apparatus 1B.

In FIG. 6B the user has moved the user input object 43 into the overlap region 41 where it can be detected by both the first apparatus 1A and the second apparatus 1B. The user may have moved the user input object 43 by making a dragging action so that the user input object 43 remains in proximity to the second apparatus 1B and does not leave the hover input region 31B of the second apparatus 1B.

The two apparatus 1A, 1B are configured to exchange information about hover inputs which are detected so that it can be determined that the overlap region 41 has been actuated. In the embodiment of FIG. 6 the determination that the overlap region 41 has been actuated may cause the function of transferring the selected item 81 from the second apparatus 1A to the first apparatus 1A to be performed.

An indication may be provided to the user to inform the user of the function which is to be performed when the overlap region 41 has been actuated. In the embodiment of FIG. 6 the indication comprises information displayed on the displays 15A, 15B. In the particular example of FIG. 6 information is displayed on the displays 15A, 15B of both the first apparatus 1A and the second apparatus 1B. In FIG. 6B the display 15A of the first apparatus 1A comprises a notification 85 that the apparatus 1A is about to receive an item 81 and the display 15B of the second apparatus 1B comprises a notification 83 that the apparatus 1B is about to send an item 81.

In FIG. 6C the user has moved the user input object 43 out of the overlap region 41. The user input object 43 is now located in the hover input region 31A of the first apparatus 1A. The user may have moved the user input object 43 by making a dragging action so that the user input object 43 remains in proximity to the first apparatus 1A and does not leave the hover input region 31A of the first apparatus 1A.

The user input which has been made in FIG. 6C may act as a confirmation that the user wishes the transfer of the selected item 81 to take place. The item 81 which was previously displayed on the display 15B of the second apparatus 1B is now displayed on the display 15A of the first apparatus 1A to indicate that the item 81 has been received the first apparatus 1A.

FIGS. 7A to 7C indicate another example embodiment of the disclosure in use. As in FIGS. 6A to 6C the Figures on the left represent a side view of the two apparatus 1A, 1B and the figures on the right represent the same apparatus 1A, 1B from the front.

In FIG. 7A the two apparatus 1A, 1B are not positioned proximate to each other. In FIG. 7A there is no communication link 33 is established between the two apparatus 1A, 1B. Also as the two apparatus 1A, 1B are not close enough together there is no overlap region 41 of the hover input regions 31A, 31B, even though the apparatus 1A, 1B are tilted relative to each other.

In FIG. 7A the user initiates a user input by positioning a user input object 43 within the hover input region 31B of the second apparatus 1B. The user input object 43 is only within the hover input region 31B of the second apparatus 1B and so is only detected by the second apparatus 1B.

The user input illustrated in FIG. 7A may cause selection of an item 91 displayed on the display 15B of the second apparatus 1B. In the embodiment of FIGS. 7A to 7C the item 91 may represent an application of the second apparatus 1B.

Another item 93 may also be displayed on the display 15A of the first apparatus 1A. The item 93 may represent an application of the first apparatus 1A.

In the embodiment of FIGS. 7A to 7C the user may wish to establish a connection between the first apparatus 1A and the second apparatus 1B to enable interaction between the applications. For example, the two applications may be calendar or contact applications and the user may wish to synchronize the content of the two applications. This may cause the exchange of data between the two apparatus 1A, 1B. In some embodiments the applications may comprise media applications which enable content such as images or videos to be displayed on the displays 15A, 15B. In such embodiments the connection may enable the media applications to be synchronized so that corresponding content may be displayed simultaneously on both the display 15A of the first apparatus 1A and the display 15B of the second apparatus 1B.

In FIG. 7B the user has moved the two apparatus 1A, 1B into proximity with each other so that there is now an overlap region 41 of the hover input regions 31A, 31B. Once the two apparatus 1A, 1B are in proximity with each other they may be configured to establish a communication link 33 for the exchange of information about hover inputs.

Once the two apparatus 1A, 1B have been positioned in proximity with each other so that there is an overlap region 41 of the hover input regions 31A, 31B and the communication link 33 may be established then an output signal may be provided to the user of the apparatus 1A, 1B to indicate that the overlap region 41 has been created. The output signal may comprise output which may be detected by the user of the apparatus 1A, 1B. For example the output signal may comprise a visual output, such a notification displayed on a display or an illumination of a light such as an LED, the output signal may also comprise an audio signal which may be provided by a loudspeaker or a tactile indication such as vibration of one or both of the apparatus 1A, 1B or any other tactile feedback. The output signal may provide an indication to the user of the apparatus 1A, 1B that it is possible to make inputs to cause a function to be performed which involves both of the apparatus 1A, 1B.

In FIG. 7B the user has moved the user input object 43 into the overlap region 41 where it can be detected by both the first apparatus 1A and the second apparatus 1B. The user may have moved the user input object 43 by making a dragging action so that the user input object 43 remains in proximity to the second apparatus 1B and does not leave the hover input region 31B of the second apparatus 1B.

The detection that the overlap region 41 has been actuated may cause the function of initiating the establishment of a connection between the application 91 on the second apparatus 1B and an application 93 on the first apparatus 1A.

An indication may be provided to the user to inform the user of the function which is to be performed. In the embodiment of FIG. 7B the indication comprises a dashed line 95 on the display 15B of the second apparatus 1B. The dashed line 95 indicates that, a connection to another application will be initiated on completion of the user input.

In FIG. 7C the user has moved the user input object 43 out of the overlap region 41. The user input object 43 is now located in the hover input region 31A of the first apparatus 1A. The user may have moved the user input object 43 by making a dragging action so that the user input object 43 remains in proximity to the first apparatus 1A and does not leave the hover input region 31A of the first apparatus 1A.

The user input which has been made in FIG. 7C may cause selection of the application 93 of the first apparatus 1 and cause the connection between the two application 91, 93 to be established. This may cause the transfer of data between the two applications 91, 93. The transfer of data may occur over the communication link 33 which was used to transfer data relating to the hover inputs or using another communication link which is established in response to detection of the user input.

A solid line 97 is indicated on the display 15A, 15B of both the first apparatus 1A and the second apparatus 1B to indicate that a connection has been established between the two applications 91, 93.

FIGS. 8A to 8C indicate another example embodiment of the disclosure in use. As in FIGS. 6A to 6C and 7A to 7C the Figures on the left represent a side view of the two apparatus 1A, 1B and the figures on the right represent the same apparatus 1A, 1B.

In FIG. 8A the two apparatus 1A, 1B are positioned proximate to each other. A communication link 33 is established between the two apparatus 1A, 1B so that the apparatus 1A, 1B can share information regarding hover inputs which have been detected.

In FIG. 8A the apparatus 1A, 1B are also tilted relative to each other so that there is an overlap region 41 of the hover input regions 31A, 31B.

In FIG. 8A content 101 is displayed on the display 15B of the second apparatus 1B. In the particular embodiment of FIG. 8 the content 101 comprises an image. The image may be, for example, a photograph. It is to be appreciated that in other embodiments any other suitable content could be displayed on the display 15B.

In FIG. 8A the user makes a user input by positioning a user input object 43 within the hover input region 31B of the second apparatus 1B. The user input may be made in the region above the area of the display 15B in which the content 101 is displayed. This may cause the content 101 to be selected so that a function may be performed on the content 101.

As the user input object 43 is only within the hover input region 31B of the second apparatus 1B and not the hover input region 31A of the first apparatus 1A the initiation of the user input is only detected by the second apparatus 1B and not also by the first apparatus 1A.

In FIG. 8B the user has moved the user input object 43 into the overlap region 41 where it can be detected by both the first apparatus 1A and the second apparatus 1B. The user may have moved the user input object 43 by making a dragging action in substantially in the direction indicated by arrow 103 so that the user input object 43 remains in proximity to the second apparatus 1B and does not leave the hover input region 31B of the second apparatus 1B.

As the user drags the user input object 43 the scale of the content 101 displayed on the display 15B may increase. The content 101 displayed on the display 15B in FIG. 8B is larger than the scale of the content displayed on the display 15B in FIG. 8A.

The detection that the overlap region 41 has been actuated may cause synchronization of the two apparatus 1A, 1B so that the content which is displayed on the display 15B of the second apparatus 1B may also be displayed on the display 15A of the first apparatus 1A.

In FIG. 8C the user has moved the user input object 43 out of the overlap region 41. The user input object 43 is now located in the hover input region 31A of the first apparatus 1A. The user may have moved the user input object 43 by making a dragging action so that the user input object 43 remains in proximity to the first apparatus 1A as indicated by the arrow 105 and then lifting the user input object 43 away from the first apparatus 1A out of the hover input region 31A as indicated by the arrow 107.

In response to the detection of the user input the controllers 4A, 4B cause the content 101 to be displayed simultaneously on both the display 15A of the first apparatus 1A and the display 15B of the second apparatus 1B. In the example embodiment of FIG. 8 the content 101 is displayed at an increased scale so that a portion of the content is displayed on the display 15A of the first apparatus 1A and another portion of the content is displayed on the display 15B of the second apparatus 1B. The two displays 15A, 15B are synchronized to function as single larger display rather than two smaller independent displays.

In FIG. 8C, once the user has made the user input so that the two displays 15A, 15B are synchronized then the overlap region 41 may no longer be needed. The second apparatus 1B may be rotated relative to the first apparatus 1A so that the two apparatus 1A, 1B are positioned proximate to each other and in horizontal alignment with each other. The two hover input regions 31A, 31B are positioned side by side with no overlap between them. This may enable the user of the apparatus 1A, 1B to view the content more easily.

Embodiments of the disclosure provide a simple and intuitive way of enabling a user to simultaneously control two apparatus to perform functions which involve both apparatus. In embodiments of the disclosure the user makes a single input which comprises at least one gesture which can be simultaneously detected by two apparatus. This input can then be used to control both of the apparatus.

The user input may be intuitive for a user to make because the user input involves both of the apparatus so it makes it clear to a user that the function which is performed will involve both of the apparatus which can detect the user input.

In some embodiments of the disclosure the user input may comprise a dragging motion which extends from one apparatus to the other through the overlap region. This may be an intuitive input for a user to make as it may enable a user to make a cognitive connection between the user input and the transfer of data or synchronisation of the two apparatus.

In some embodiments of the disclosure it may be necessary to tilt the apparatus relative to each other on order to enable the overlap region to be created. This may be an intuitive action for a user to make as it may mimic the action of pouring content from one apparatus to the other.

Although embodiments of the present disclosure have been described in the preceding paragraphs with reference to various examples, it should be appreciated that modifications to the examples given can be made without departing from the scope of the disclosure as claimed. For example in the above described embodiments a hover user input device is used to detect an input which is detectable by two apparatus simultaneously. In other embodiments other user input devices may be used such as image capturing and tracking devices or position sensors.

In embodiments of the disclosure only two apparatus are used. In other embodiments more than two apparatus may be positioned in proximity to each other. This may enable the synchronization of more than two apparatus, for example a user may wish to synchronize files such as contacts or calendars in more than two apparatus or to perform functions on more than two apparatus.

It is also to be appreciated that other functions could be performed by the two apparatus 1A, 1B using embodiments of the disclosure. For example one of the apparatus could be used to view content such as images while the other apparatus could be used to control the content displayed, for example by scrolling through content or navigating through menu structures.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the disclosure believed to be of particular importance it should be understood that the Applicant claims protection in respect of any patentable feature or combination of features hereinbefore referred to and/or shown in the drawings whether or not particular emphasis has been placed thereon.

I/we claim:

1. A method comprising:
detecting a user input at a first apparatus;
determining that the user input was also detectable by a second apparatus; and
causing a function to be performed where at least part of the function is performed by the first apparatus and at least part of the function is performed by the second apparatus.

2. A method as claimed in claim 1 wherein the user input comprises bringing a user input object into proximity of both the first apparatus and the second apparatus so that the user input object is simultaneously detectable by both the first apparatus and the second apparatus.

3. A method as claimed in claim 1 wherein the user input comprises bringing a user input object into proximity of the first apparatus, so that the user input object is detectable by the first apparatus, and moving the user input object to a region where it is in proximity of both the first apparatus and the second apparatus so that the user input object is simultaneously detectable by both the first apparatus and the second apparatus.

4. A method as claimed in claim 1 wherein the user input comprises a hover input which is simultaneously detectable by both the first apparatus and the second apparatus.

5. A method as claimed in claim 1 comprising determining, by the first apparatus that the second apparatus is proximate to the first apparatus.

6. A method as claimed in claim 1 comprising determining that the first apparatus is tilted relative to the second apparatus.

7. A method as claimed in claim 1 comprising establishing a communication link between the first and second apparatus.

8. A method as claimed in claim 7 wherein the communication link comprises a wireless communication link.

9. A method as claimed in claim 8 wherein the communication link comprises a short range wireless communication link.

10. A method as claimed in claim 1 comprising receiving a notification from the second apparatus indicating that the second apparatus has also detected the user input.

11. A method as claimed in claim 10 wherein the notification is received over the communication link.

12. A method as claimed in claim 1 wherein the function which is performed comprises transferring information between the first apparatus and the second apparatus.

13. A method as claimed in claim 1 wherein the function which is performed comprises establishing a further communication link between the first apparatus and the second apparatus.

14. A method as claimed in claim 1 wherein the function which is performed comprises coordinating a display of the first apparatus and a display of the second apparatus so that corresponding content may be simultaneously displayed on both the display of the first apparatus and the display of the second apparatus.

15. A method as claimed in claim 1 wherein the function which is performed depends upon the user input which is detected.

16. An apparatus comprising:
at least one processor; and
at least one memory including computer program code;
wherein the at least one memory and the computer program code are configured to, with the at least one processor, enable the apparatus to:
detect a user input of the apparatus;
determine that the user input was also detectable by another apparatus; and
cause a function to be performed where at least part of the function is performed by the apparatus and at least part of the function is performed by the another apparatus.

17. An apparatus as claimed in claim 16 wherein the user input comprises bringing a user input object into proximity of both the apparatus and the another apparatus so that the user input object is simultaneously detectable by both the apparatus and the another apparatus.

18. An apparatus as claimed in claim 16 wherein the user input comprises bringing a user input object into proximity of the apparatus, so that the user input object is detectable by the apparatus, and moving the user input object to a region where it is in proximity of both the apparatus and the another apparatus so that the user input object is simultaneously detectable by both the apparatus and the another apparatus.

19-30. (canceled)

31. A non transitory physical entity embodying a computer program comprising computer program instructions that, when executed by at least one processor, cause an apparatus at least to perform:
detecting a user input at a first apparatus;
determining that the user input was also detectable by a second apparatus; and
causing a function to be performed where at least part of the function is performed by the first apparatus and at least part of the function is performed by the second apparatus.

32-34. (canceled)

35. A user interface comprising:
a user input device configured to detect a user input at an apparatus wherein the user input is also detectable by a user input device at another apparatus such that, in response to determining that the user input has also been detected at the another apparatus a function is caused to be performed where at least part of the function is performed by the apparatus and at least part of the function is performed by the another apparatus.

36. (canceled)
